(19) United States
(12) Patent Application Publication
(10) Pub. No.: US 2025/0259018 A1
(43) Pub. Date: Aug. 14, 2025

(54) INTERCHANGEABLE LARGE LANGUAGE MODELS FOR CONTEXT COMPUTING DEVICES

(71) Applicant: Humane, Inc., San Francisco, CA (US)

(72) Inventors: Kenneth Luke Kocienda, Mill Valley, CA (US); Imran A. Chaudhri, San Francisco, CA (US)

(21) Appl. No.: 19/048,836

(22) Filed: Feb. 7, 2025

Related U.S. Application Data
(60) Provisional application No. 63/552,075, filed on Feb. 9, 2024.

(51) Int. Cl. G06F 40/40; G06F 40/30

(52) U.S. Cl. CPC G06F 40/40; G06F 40/30

(57) ABSTRACT

This disclosure relates generally to the management of large language models on artificial intelligence (Ai) enabled devices. In some embodiments, a method comprises: receiving, from a device, a request for information, the request including text-input and context data; determining, with at least one processor, a large language model from a plurality of large language models based at least in part on the context data; providing, with the at least one processor, the text-input, or input data derived from the text-input into the large language model; and sending the output of the large language model, or data derived from the output of the large language model to the device for further processing or output by the device or another device.

### RELATED APPLICATION

This application claims the benefit of priority from U.S. Provisional Application No. 63/552,075, filed Feb. 9, 2024, which is incorporated by reference herein in its entirety.

### TECHNICAL FIELD

This disclosure relates generally to large language models.

### BACKGROUND

A large language model (LLM) is typically used for general-purpose language generation. An LLM can be implemented as an artificial neural network that is built with a transformer-based architecture or other architectures, such as recurrent neural network (RNN) variants or a structured state space sequence (S4) model (e.g., Mamba). LLMs learn statistical relationships from text documents during a self-supervised and semi-supervised training process. LLMs can be used for text generation by taking an input text and repeatedly predicting a next token or word. Some examples of LLMs include Open AI's GPT series (e.g., GPT-3.5 and GPT-4 used in ChatGPT), A Dot LLM (which is specialized for the Korean language) and SoftBank LLM (which is specialized for the Japanese language).

### SUMMARY

An LLM used by a device (e.g., a context-aware device) is determined from multiple LLMs based on context data and/or other data provided by the device and/or other sources (e.g., personal information databases). The LLM can be customized per geographic region to satisfy particular cultural, language, or service requirements. The interchangeability of the LLM serves the need to properly interact with these cultures, languages, or services. The LLM can be determined based on the language of the user captured by a microphone of the device. The LLM can be determined based the language selected by the user for device. In some embodiments, the LLM can be determined based on a setting selected by the user in a settings menu or other input mechanism. In some embodiments, a standard LLM (e.g., language agnostic LLM) can be used to categorize a request, and then forward that request to a particular LLM (e.g., an LLM specialized to a particular language) based on the categorization.

### BRIEF DESCRIPTION OF DRAWINGS

FIG. 1 illustrates a software architecture for swappable LLMs, where the LLM is customized for the United States, according to one or more embodiments.

FIG. 2 illustrates a software architecture for swappable LLMs, where the LLM is customized for Korea, according to one or more embodiments,

FIG. 3 illustrates a software architecture for swappable LLMs, where the LLM is customized for Japan, according to one or more embodiments.

### DETAILED DESCRIPTION

The embodiments described below are applicable to an operating system (OS) for an Ai enabled device such as, for example, a wearable computer that uses an LLM for contextual computing, such as described in U.S. Pat. No. 10,924,651, for “Wearable Multimedia Device and Cloud Computing Platform with Application Ecosystem,” issued Feb. 21, 2021, which is incorporated by reference herein in its entirety. The disclosed embodiments, however, are also applicable to any device that utilizes LLMs. An example commercial product is the contextual computing device, “Ai Pin”, developed by Humane Inc., of San Francisco, California USA, which uses an operating system called “Cosmos,” that utilizes LLMs.

The device can include various input mechanisms, such as, for example, an ephemeral user interface projected on a surface by a laser beam scanning projector of the device, a touch screen, surface or pad, and one or more microphones. The device can also include various output mechanisms, such as, e.g., computer display or monitor, an ephemeral laser projected display, a loudspeaker, LED lights, etc. The device can be an augmented/virtual/extended reality headset, glasses, goggles, chest mounted or wrist mounted device.

When a user interacts with the device, the interaction can be in the form of speech, gestures on a touchpad, or interaction with laser projected ephemeral user interface projected by the device on a surface (e.g., projected on the user's hand). In all of these interactions, the OS renders the input request (or event) into a natural language representation, encapsulating the actual input (what the user actually said or did) with some metadata about the form of the input (e.g., speech, gesture, etc.) and some system context (e.g., location, time of day, etc.).

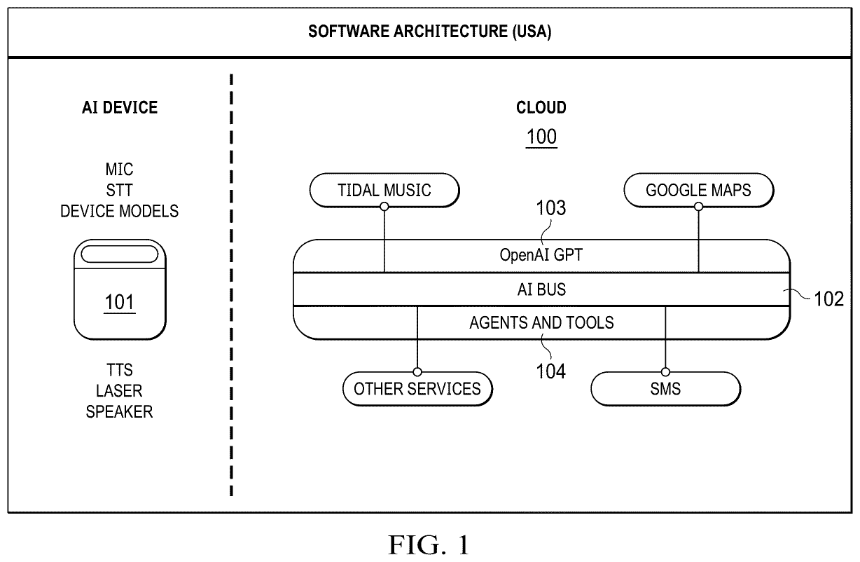

FIG. 1 illustrates a cloud computing platform 100 for swappable LLMs where the LLM is customized for the United States, according to one or more embodiments, according to one or more embodiments.

An Ai device 101 contacts cloud computing platform 100 and sends the input (e.g., text-based input) and context data in the form of a request to a system bus 102 on cloud based platform 100. The system bus 102 unpacks the information received from the device 101 with the request and submits the text to an LLM 103 to determine the intent of the request. The LLM 103 processes the text and consults an array of available agents/tools/or services 104 on cloud platform 100 to respond to the request. The LLM 103 builds a plan for how to satisfy the intent using one or more of these agents/tools/services 104 (e.g., music service, map service). In this example, the LLM 103 is customized for the US culture, language, services, etc. For example, in FIG. 1 the LLM 103 is OpenAI GPT and services 104 include Google Map®s, Tidal Music® and SMS messaging service.

In some embodiments, text to speech (TTS) conversion is performed on device 101. In other embodiments, text to speech (TTS) and speech to text (STT) conversion is performed on cloud computing platform 100.

In some embodiments, the LLM 103 may restructure the input request information into a form suitable for processing and may add an additional request to consult additional context data (e.g. personal information databases that the user opts into) that are available on or accessible from the cloud computing platform 100. The LLM 103 communicates this plan back to the system bus 102 for processing. The system bus 102 invokes the agents, tools, and/or services 104 with the input information and additional context (if any). Once this processing is completed, the system bus 102 consults the LLM 103 once more to determine if the intent of the request has been met. If the intent is not met, the system bus 102 repeats the foregoing steps. If the intent of the request has fully been met, the LLM 103 is consulted once again to format a response. This response includes sufficient information to determine what experience to invoke on the device 101, such as, e.g., text to speech back to the user via voice, and/or content projected in laser ink on a surface by a laser projector of the device 101.

In all the above steps, the LLM 103 is interchangeable. For example, the LLM 103 can be customized per geographic region to satisfy particular cultural, language, or service requirements. The interchangeability of the LLM 103 serves the need to properly interact with these cultures, languages, or services.

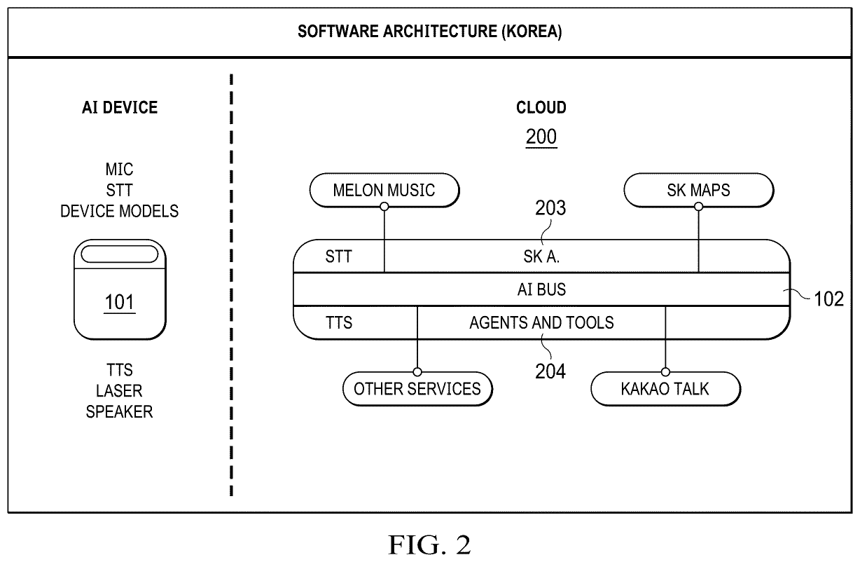

FIG. 2 illustrates a cloud computing platform 200 where the LLM is customized for Korea, according to one or more embodiments. In particular, the LLM 203 is customized for the Korean cultures, language, services, etc. For example, in FIG. 2 the LLM 203 is the SK Telecom® Co. Korean LLM “A.” or “ADot” which is specialized for the Korean language, and the services 204 include Melon Music®, SK Maps and Kakao Talk messaging service.

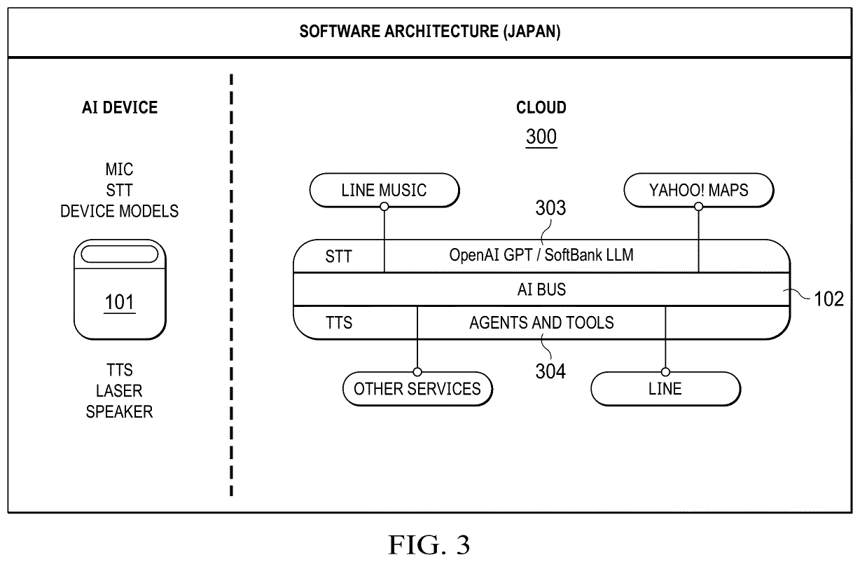

FIG. 3 illustrates a cloud computing platform 300 where the LLM 303 is customized for Korea, according to one or more embodiments. In particular, the LLM 303 is customized for the Korean cultures, language, services, etc. In particular, the LLM 303 is OpenAIR GPT or SoftBank® LLM which is specialized for the Japanese language, and the services 304 are Line Music®, Yahoo®! Maps and Line® messaging service.

In some embodiments, the agents 104, 204, 304 are LLM-powered subprocesses allowing the operating system to work in a composable fashion. The agents/tools/services 104, 204, 304 can be traditional, non-AI powered code and application programming interfaces (APIs) which are available for direct invocation on the system bus 102, 202, 203, on the cloud computing platform 100, 200, 300, e.g., various databases. Agents/tools/services 104, 204, 304 can be external to the system bus 102, 202, 302 and the cloud computing platform 100, 200, 300, e.g. music, messaging, mapping services, etc. Customization can occur at any touch point, and the LLM 103, 203, 303 can be abstracted at points where it is called and receives replies from the LLM 103, 203, 303. In this manner, the software architecture is agnostic to LLMs.

In some embodiments, a one-time setting of a LLM 103, 203, 303 can be provided by, for example, a carrier or retail partner to lock in the use of that specific LLM for a particular market or sales environment.

In some embodiments, the operating system can provide a mapping of the user interface language to the LLM 103, 203, 303, and switch between these different LLMs using this mapping when the user changes the user interface language in, for example, in a settings menu of the device 101. For example, if the user interface is in English then the LLM 103 can be OpenAI. If the user changes the user interface language to Korean in a settings menu, then the LLM 203 (e.g., ADot) can be automatically swapped into operation.

In some embodiments, the operating system of device 101 can provide a custom setting which gives the user control over which LLM to use to suit their preferences. For example, some users might prefer an open-source LLM for personal reasons.

In some embodiments, the choice of LLM can be made on the fly. For example, the operating system can auto-detect the language spoken into a microphone of the device 101 by the user and choose the most appropriate LLM based on the spoken language.

In some embodiments, the operating system can choose the LLM based on geography (e.g., determined by a GPS or other satellite communication receiver on device 101). For example, when an American user visits Korea, the LLM can automatically swapped to LLM 203, the Korea-based LLM (e.g., ADot).

In some embodiments, the operating system can use a first LLM to categorize a request, and then forward that request to one or more other LLMs based on the categorization. For example, a request to play a song on the Tidal® service might get routed to OpenAI® GPT, while a request to send a Kakao® message might get routed to a Korea-based messaging LLM 203 (e.g., ADot®).

In some embodiments, the LLMs 103, 203, 303 or a portion thereof are downloaded to device 101, where the LLMs 103, 203, 303 process at least a portion of the text data and/or context data. In other embodiments the LLMs 103, 203, 303 reside on the cloud computing platform 100, 200, 300. In still other embodiments, the LLMs 103, 203, 303 reside on both the device 101 and cloud computing platform 100, 200, 300. The LLMs 103, 203, 303 can be downloaded to device 101 based on the context data, such as geography, language spoken, etc.

In some embodiments, the LLM 103, 203, 303 is a DeepSeek™ LLM as described in Xiao Bi et al., “DeepSeek LLM: Scaling Open-Source Language Models with Longtermism,” arXiv:2401.02954v1 (5 Jan. 2024).

The details of the disclosed embodiments are set forth in the accompanying drawings and the description below. Other features, objects and advantages are apparent from the description, drawings, and claims.

A number of implementations have been described. Nevertheless, it will be understood that various modifications may be made. Elements of one or more implementations may be combined, deleted, modified, or supplemented to form further implementations. In yet another example, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

1. A system comprising:
a communication interface configured to receive a request for information from a device over a network, the request including text-input and context data;
a system bus for determining a large language model from a plurality of large language models based at least in part on the context data;
providing the text-input, or input data derived from the text-input into the large language model; and
sending the output of the large language model, or data derived from the output of the large language model to the device for further processing or output by the device or another device.

2. The system of claim 1, wherein the context data includes location data.

3. The system of claim 1, wherein the plurality of large language models are customized for a particular geographic region.

4. The system of claim 1, wherein the plurality of large language models are customized for a particular culture or language or service.

5. The system of claim 1, wherein the LLM restructures the request for information into a form suitable for processing and adds an additional request to consult additional context data that are available on or accessible from the network.

6. The system of claim 1, wherein the request for information is converted to a natural language representation, and the request for information encapsulates and text or speech input from a user with metadata about the form of the actual input.

7. The system of claim 1, wherein the system bus:
invokes at least one agent, tool, or service on the device based on the request for information;
consults the LLM to determine if the intent of the request for information has been met;
in accordance with the intent of the request not fully being met, resending the request for information;
in accordance with the intent of the request being fully met, requesting the LLM to format a response for presentation on the device.

8. The system of claim 1, wherein the LLM categorizes the request for information and forwards the request for information to another LLM based on the categorization.

9. The system of claim 1, wherein the LLM or a portion thereof is downloaded to the device, and processes at least a portion of the text data or context data on the device.

10. The system of claim 1, wherein the LLM is a DeepSeek™ LLM.

11. A method comprising:
receiving, from a device, a request for information, the request including text-input and context data;
determining, with at least one processor, a large language model from a plurality of large language models based at least in part on the context data;
providing, with the at least one processor, the text-input, or input data derived from the text-input into the large language model; and
sending the output of the large language model, or data derived from the output of the large language model to the device for further processing or output by the device or another device.

12. The method of claim 11, wherein the context data includes location data.

13. The method of claim 11, wherein the plurality of large language models are customized for a particular geographic region.

14. The method of claim 11, wherein the plurality of large language models are customized for a particular culture or language or service.

15. The method of claim 11, wherein the LLM restructures the request for information into a form suitable for processing and adds an additional request to consult additional context data that are available on or accessible from the network.

16. The method of claim 11, wherein the request for information is converted to a natural language representation, and the request for information encapsulates and text or speech input from a user with metadata about the form of the actual input.

17. The method of claim 11, wherein the system bus:
invokes at least one agent, tool, or service on the device based on the request for information;
consults the LLM to determine if the intent of the request for information has been met;
in accordance with the intent of the request not fully being met, resending the request for information;
in accordance with the intent of the request being fully met, requesting the LLM to format a response for presentation on the device.

18. The method of claim 11, wherein the LLM categorizes the request for information and forwards the request for information to another LLM based on the categorization.

19. The method of claim 11, wherein the LLM or a portion thereof is downloaded to the device, and processes at least a portion of the text data or context data on the device.

20. The method of claim 11, wherein the LLM is a DeepSeek™ LLM.
